(19) United States
(12) Patent Application Publication
(10) Pub. No.: US 2008/0116071 A1
(43) Pub. Date: May 22, 2008

(54) Oxygen Sensor Degradation Judging Device

(75) Inventors: Motonori Nakamura, Gunma (JP); Akira Uchikawa, Gunma (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 11/795,246

(22) PCT Filed: Jan. 11, 2006
(86) PCT No.: PCT/JP06/00216

§ 371 Date: Jul. 13, 2007

(30) Foreign Application Priority Data
Jan. 17, 2005 (JP) 2005-009126

(51) Int. Cl. G01N 27/26

(52) U.S. Cl. 204/427

(57) ABSTRACT

This device is a degradation judging device for an oxygen sensor having a reference electrode 23 and a measuring electrode 22, both of which hold a solid electrolyte layer therebetween, and measuring oxygen concentrations based on an electromotive force that occurs in accordance with a difference between an oxygen partial pressure of the reference electrode 23 and an oxygen partial pressure of the measuring electrode 22. A control unit 10, which controls operations of intake and exhaust valves, a spark plug and a fuel injection valve, has a degradation judging means that detects an internal resistance value “R1” of the solid electrolyte layer 21 by applying a high-frequency alternating current between the reference electrode 23 and the measuring electrode 22, and judges degradation of the solid electrolyte layer 21 by comparing an average value of the detected internal resistance value “R1” with a reference value. By this judgment, the degradation of the solid electrolyte layer 21 can accurately be judged, and an occurrence of the engine stall or emission failure can be prevented.

### TECHNICAL FIELD

The present invention relates to, for example, a degradation judging device for an oxygen sensor, which judges the degradation of a solid electrolyte layer forming the oxygen sensor used for an air fuel ratio control of an internal combustion engine.

### BACKGROUND ART

As a conventional oxygen sensor, an oxygen sensor having a reference electrode and a measuring electrode, both of which hold a solid electrolyte layer therebetween, and measuring oxygen concentrations by measuring voltage between the both electrodes under a condition where a voltage is applied between the reference electrode and the measuring electrode and an oxygen partial pressure between the both electrodes is controlled, has been known.

With this oxygen sensor, rich (little oxygen, much fuel)/lean (much oxygen, little fuel) of the air fuel ratio (λ) is judged based on a measurement result of the oxygen concentrations, and thereby controlling the air fuel ratio of the internal combustion engine.

In the conventional technique, the degradation of the oxygen sensor is judged from an internal combined or total impedance of the oxygen sensor, which is calculated on the basis of a variation amount of an output voltage of the oxygen sensor through the application of a specified voltage to the oxygen sensor (for example, see Patent Publication 1).

### Patent Publication 1: Japanese Patent Application Kokai Publication No. 4-233447

### DISCLOSURE OF THE INVENTION

### Problems Solved by the Invention

However, in the conventional degradation judging way, since the internal total impedance of the oxygen sensor is measured, the degradation of the solid electrolyte layer forming the oxygen sensor can not be determined.

Thus, by the conventional degradation judging way, there is a risk that the oxygen sensor will be judged to be activated (=to be a normal condition), despite the fact that the output value of the oxygen sensor becomes large by reason that the solid electrolyte layer suffers from catalyst poisoning by Si residing in an exhaust gas and then an internal resistance value of the solid electrolyte layer increases (deteriorates) or by reason that the internal resistance value of the solid electrolyte layer is hard to decrease because a temperature of the solid electrolyte layer does not increase rapidly. That is to say, despite the lean condition, the condition is judged to be the rich condition, and this could therefore cause an engine stall or emission failure.

The present invention has been made to solve the above problems, and the aim is to provide the degradation judging device for the oxygen sensor, which is capable of precisely judging the degradation of the solid electrolyte layer.

### Means to Solve the Problems

In order to achieve the aim, in the invention described in claim 1, a degradation judging device particularly has a control unit detecting an internal resistance value of a solid electrolyte layer by applying a high-frequency alternating current between reference and measuring electrodes, and judging degradation of the solid electrolyte layer by comparing the detected internal resistance value and a reference value.

Since the degradation judging device of an oxygen sensor according to the present invention judges the degradation of the solid electrolyte layer in accordance with the internal resistance value of the solid electrolyte layer, the degradation of the solid electrolyte layer can accurately be judged, and an occurrence of the engine stall or emission failure can be prevented.

In the invention described in claim 2, the control unit judges that the solid electrolyte layer deteriorates when the internal resistance value becomes greater than or equal to the reference value.

In the invention described in claim 3, the degradation judging device has a heater portion for heating up the solid electrolyte layer, and the control unit judges that the solid electrolyte layer deteriorates when the internal resistance value becomes greater than or equal to the reference value, and heats up the solid electrolyte layer to a temperature at which the internal resistance value becomes the reference value by controlling an applied voltage to the heater portion.

According to this invention, it is possible to lower the internal resistance value of the solid electrolyte layer, and to return the solid electrolyte layer to the activated state, and thereby obtaining a right sensor output.

In the invention described in claim 4, when the applied voltage to the heater portion, which corresponds to the temperature at which the internal resistance value becomes the reference value, is greater than or equal to a battery voltage, the control unit delays a judging timing at which an activation state of the solid electrolyte layer is judged until the solid electrolyte layer heats up to the temperature at which the internal resistance value becomes the reference value.

According to this invention, by waiting for the temperature of the solid electrolyte layer to increase, the degradation of the solid electrolyte layer can accurately be judged.

In the invention described in claim 5, the control of the applied voltage to the heater portion is performed by a map or computation, which is formed by the internal resistance value of the solid electrolyte layer, a heater voltage and an activation judgment delay value.

In the invention described in claim 6, the control unit applies a 10 MHz high-frequency alternating current between the reference and measuring electrodes, and in a case of an increase of 50[%] or more of the internal resistance value of the solid electrolyte layer, the control unit judges that the solid electrolyte layer deteriorates.

In the invention described in claim 7, a degradation judging device of an oxygen sensor provided with a reference electrode and a measuring electrode, both of which hold a solid electrolyte layer therebetween, the oxygen sensor measuring oxygen concentrations based on an electromotive force that occurs in accordance with a difference between an oxygen partial pressure on a side of the reference electrode and an oxygen partial pressure on a side of the measuring electrode, and having a system that accumulates the oxygen on the side of the reference electrode, the degradation judging device has a control unit detecting an internal resistance value of the solid electrolyte layer by applying a high-frequency alternating current between the reference and measuring electrodes, and judging degradation of the solid electrolyte layer by comparing the detected internal resistance value and a reference value.

In the invention described in claim 8, the control unit judges that the solid electrolyte layer deteriorates when the internal resistance value becomes greater than or equal to the reference value.

In the invention described in claim 9, the degradation judging device has a heater portion for heating up the solid electrolyte layer, and the control unit judges that the solid electrolyte layer deteriorates when the internal resistance value becomes greater than or equal to the reference value, and heats up the solid electrolyte layer to a temperature at which the internal resistance value becomes the reference value by controlling an applied voltage to the heater portion.

In the invention described in claim 10, when the applied voltage to the heater portion, which corresponds to the temperature at which the internal resistance value becomes the reference value, is greater than or equal to a battery voltage, the control unit delays a judging timing at which an activation state of the solid electrolyte layer is judged until the solid electrolyte layer heats up to the temperature at which the internal resistance value becomes the reference value.

In the invention described in claim 11, the control unit judges that the solid electrolyte layer deteriorates when the internal resistance value becomes greater than or equal to the reference value, and raises a slice level which is compared with an output value of the oxygen sensor, more than a normal value, according to an increment of the internal resistance value with respect to the reference value.

In the invention described in claim 12, the slice level being compared with the output value of the oxygen sensor is shifted by a map or computation, which is formed by the internal resistance value of the solid electrolyte layer, a heater voltage, an activation judgment delay value and a slice level offset amount.

In the invention described in claim 13, the control unit applies a 10 MHz high-frequency alternating current between the reference and measuring electrodes, and in a case of an increase of 50[%] or more of the internal resistance value of the solid electrolyte layer, the control unit judges that the solid electrolyte layer deteriorates.

### BRIEF DESCRIPTION OF DRAWINGS

FIG. 1 is a schematic system diagram showing a system of an internal combustion engine according to the present invention.

FIG. 2 are a sectional view showing a configuration of an oxygen sensor illustrated in FIG. 1, and its equivalent circuit.

FIG. 3 is a flow chart showing a flow of a condition judgment process according to the present invention.

FIG. 4 is a flowchart showing a flow of a degradation judgment process according to the present invention.

FIG. 5 are drawings showing a change of an internal resistance value according to a frequency change of an alternating current.

FIG. 6 is a drawing showing a change of the internal resistance value according to increase of a device temperature.

FIG. 7 is a drawing to explain a process in which a slice level of the output voltage of the oxygen sensor is offset.

### DESCRIPTION OF THE PREFERRED EMBODIMENTS

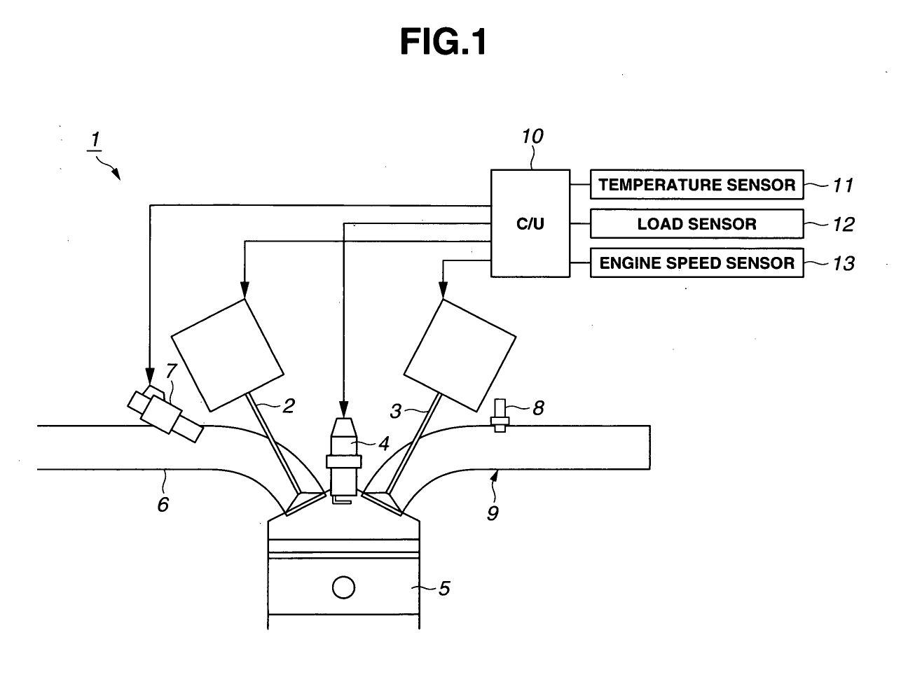

A degradation judging device of the present invention can be applied to, for example, an air fuel ratio control of an internal combustion engine illustrated in FIG. 1. In the following, a system of the internal combustion engine of one embodiment of the present invention will be explained with reference to the drawings.

[System of the Internal Combustion Engine]

As illustrated in FIG. 1, the internal combustion engine 1 of the embodiment of the present invention includes, as main elements, a cylinder 5 having an intake valve 2, an exhaust valve 3 and a spark plug 4, a fuel injection valve (injector) 7 provided inside an intake port 6, an oxygen sensor 8 detecting oxygen concentrations in an exhaust port 9, and a control unit (C/U) 10 controlling operations of the intake valve 2, the exhaust valve 3, the spark plug 4 and the fuel injection valve 7.

In addition, a temperature sensor 11 that senses engine operating temperatures such as an engine coolant temperature of the internal combustion engine 1, a lubricating oil temperature and an outside air temperature, a load sensor 12 that detects a load of the internal combustion engine 1 such as a throttle opening, and an engine speed sensor 13 that detects the number of revolutions of the internal combustion engine 1, are connected to the control unit 10. The control unit 10 is configured such that information detected by these sensors are input to the control unit 10.

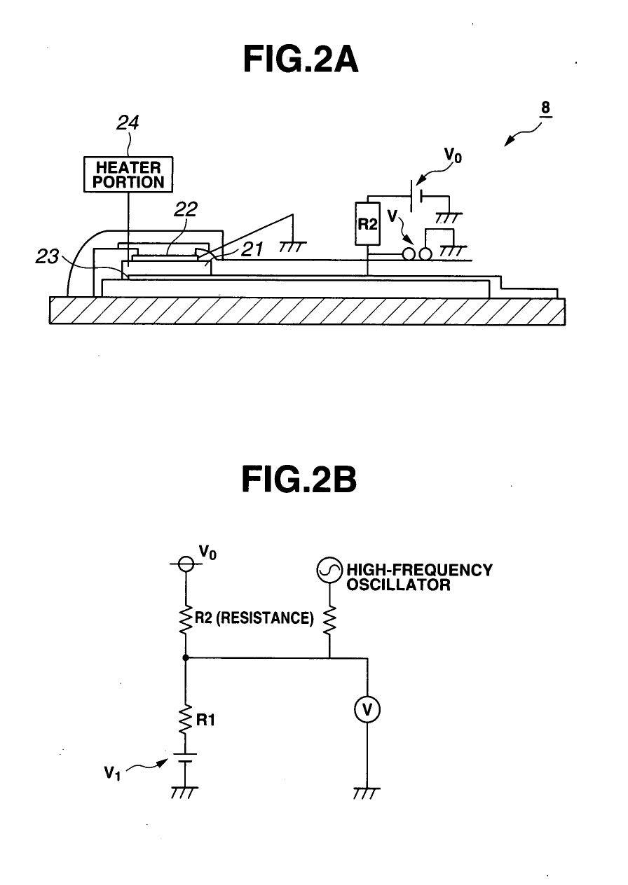

Further, as illustrated in FIG. 2, the oxygen sensor 8 has a measuring electrode 22 and a reference electrode 23, both of which hold a solid electrolyte layer 21 between the electrodes 22, 23. The oxygen sensor 8 detects the oxygen concentrations based on an electromotive force “V” that occurs in accordance with a difference between an oxygen partial pressure on a side of the reference electrode 23 and an oxygen partial pressure on a side of the measuring electrode 22 through the application of a bias voltage “V₀” between the measuring electrode 22 and the reference electrode 23. The solid electrolyte layer 21 is formed so that the solid electrolyte layer 21 can be heated up and activated by a heater portion 24 which heats up by an applied voltage.

Here, in general, when an internal resistance value “R1” (see FIG. 2B) of the solid electrolyte layer 21 forming the oxygen sensor 8 increases (deteriorates) by reason of the catalyst poisoning by Si residing in the exhaust gas, or when the internal resistance value “R1” of the solid electrolyte layer 21 is hard to decrease because a temperature of the solid electrolyte layer 21 does not increase rapidly, an output value “V” of the oxygen sensor 8 becomes large.

Thus, by the conventional degradation judging way, because of the above reason, despite the fact that the output value “V” of the oxygen sensor 8 becomes large, the solid electrolyte layer 21 is judged to be activated. In other words, despite the lean condition, the condition is judged to be the rich condition, and this could therefore cause an engine stall or emission failure.

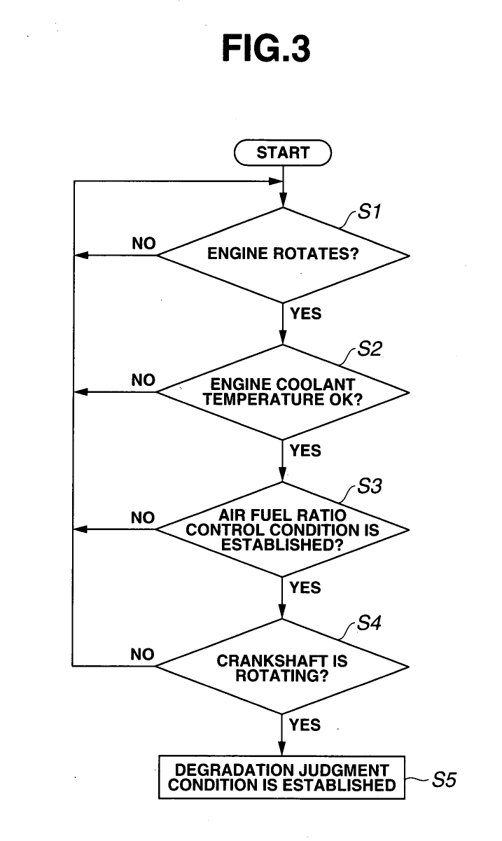

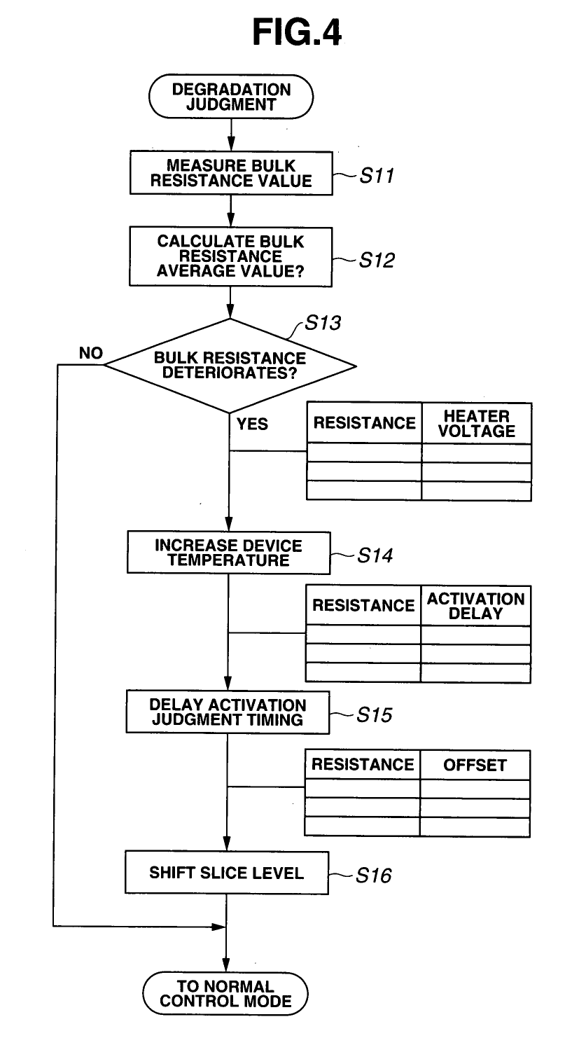

Accordingly, in this internal combustion engine 1, the control unit 10 executes the following condition judgment process and degradation judgment process, and thereby precisely detecting the degradation of the solid electrolyte layer 21. In the following, an operation of the control unit 10 at the execution of these condition judgment and degradation judgment processes, will be explained with reference to flow charts shown in FIGS. 3 and 4.

[Condition Judgment Process]

Firstly, the operation of the control unit 10 at the execution of the condition judgment process in which a judgment is made as to whether or not a condition for start of the degradation judgment of the solid electrolyte layer 21 is satisfied, will be explained with reference to the flow chart shown in FIG. 3.

In the flow chart of FIG. 3, the routine starts when an ignition switch of a vehicle is turned ON, and the routine of the condition judgment process proceeds to step S1.

In the process of step S1, the control unit 10 judges whether or not the internal combustion engine 1 rotates from a detection result of the engine speed sensor 13. When the internal combustion engine 1 rotates, the routine of the condition judgment process proceeds to step S2 by the control unit 10.

In the process of step S2, the control unit 10 judges whether or not the engine coolant temperature of the internal combustion engine 1 is within a specified control range from a detection result of the temperature sensor 11. As a result of the judgment, when the engine coolant temperature is not within the specified control range, the routine of the condition judgment process is returned to step S1 by the control unit 10. On the other hand, when the engine coolant temperature is within the specified control range, the routine proceeds to step S3 by the control unit 10.

In the process of step S3, the control unit 10 judges whether or not a specified air fuel ratio (λ) control condition is established. As a result of the judgment, when the air fuel ratio control condition is not established, the routine of the condition judgment process is returned to step S1 by the control unit 10. On the other hand, when the air fuel ratio control condition is established, the routine proceeds to step S4 by the control unit 10.

In the process of step S4, the control unit 10 judges whether or not an engine crankshaft rotates. As a result of the judgment, when the engine crankshaft does not rotate, the routine of the condition judgment process is returned to step S1 by the control unit 10. On the other hand, when the engine crankshaft rotates, the control unit 10 judges that the degradation judgment condition is established, and a cycle of the condition judgment process is terminated.

[Degradation Judgment Process]

Next, the operation of the control unit 10 at the execution of the degradation judgment process which judges the degradation of the solid electrolyte layer 21, will be explained with reference to the flow chart shown in FIG. 4.

In the flow chart of FIG. 4, the routine starts when the degradation judgment condition is judged to be established in the condition judgment process, and the routine of the degradation judgment process proceeds to step S11.

In the process of step S11, the control unit 10 applies an alternating current of about 10 MHz high-frequency to the oxygen sensor, and detects the internal resistance value (bulk resistance value) “R1” of the solid electrolyte layer 21 a predetermined times (for instance, 100 times).

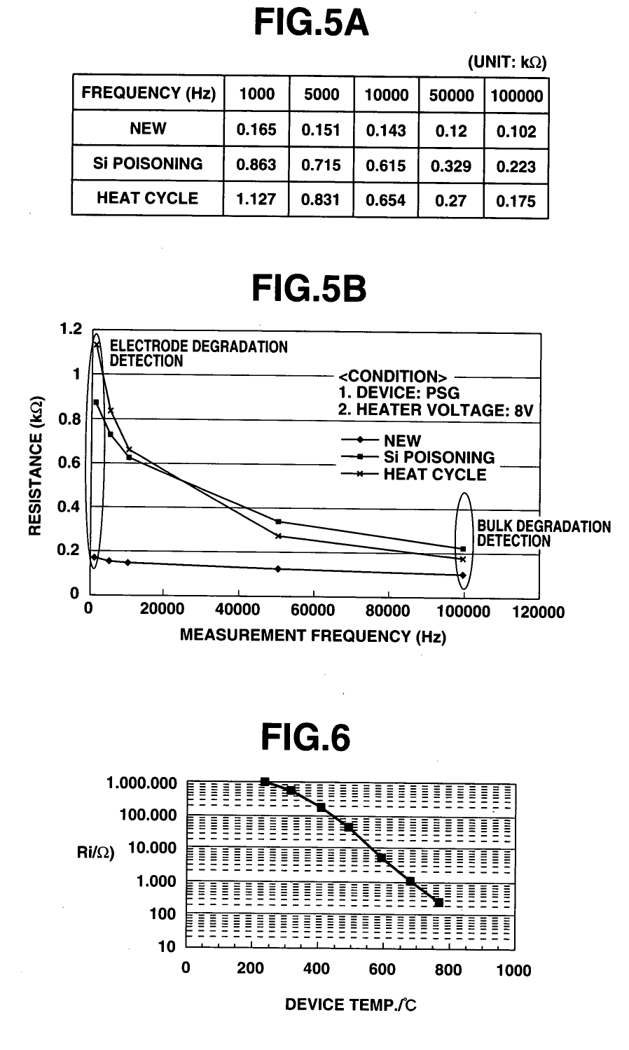

Here, as illustrated in FIG. 5A, the internal resistance value of the oxygen sensor, which deteriorates by the catalyst poisoning by Si or by heat cycle, generally becomes large as compared with the internal resistance value of a new oxygen sensor. Further, as illustrated in FIG. 5B, it is generally known that when applying the alternating current between the measuring electrode 22 and the reference electrode 23 of the oxygen sensor 8, the degradation of the electrode can be detected from the internal resistance value in a low-frequency region, and the degradation of the solid electrolyte layer 21 can be detected from the internal resistance value in a high-frequency region.

Consequently, as described above, by applying the alternating current of about 10 MHz high-frequency to the oxygen sensor, the internal resistance value “R1” of the solid electrolyte layer 21 can be detected. By this process, step S11 ends, and the routine of the degradation judgment process proceeds to step S12.

In the process of step S12, the control unit 10 calculates an average value of the internal resistance value “R1” detected by the process at step S11 as a bulk resistance average value “Rav”. By this process, step S12 ends, and the routine of the degradation judgment process proceeds to step S13.

In the process of step S13, the control unit 10 compares the bulk resistance average value “Rav” calculated by the process at step S12 and an initial data (reference value) of the internal resistance value “R1”, and then judges whether or not the solid electrolyte layer 21 deteriorates.

More specifically, in a case where the bulk resistance average value “Rav” changes more than 50% (the change of 50% or more) with respect to the reference value, the control unit 10 judges that the solid electrolyte layer 21 deteriorates. Thus, as a result of the judgment, in a case where the solid electrolyte layer 21 does not deteriorate, the control unit 10 finishes a cycle of the degradation judgment process, and the routine proceeds to a normal control mode that judges the degradation of the electrode. On the other hand, in the case where the solid electrolyte layer 21 deteriorates, the routine of the degradation judgment process proceeds to step S14 by the control unit 10.

In the process of step S14, the control unit 10 refers to a map showing a relationship between the bulk resistance average value “Rav” and a heater voltage, and reads the heater voltage corresponding to the bulk resistance average value “Rav” calculated by the process at step S12. The control unit 10, then, applies the read heater voltage to the heater portion 24, and thereby heats up the solid electrolyte layer 21 until the internal resistance value “R1” becomes the reference value. As illustrated in FIG. 6, the internal resistance value “R1” of the solid electrolyte layer 21 generally decreases according to the increase of a sensor (device) temperature. Therefore, by this process, the internal resistance value “R1” of the solid electrolyte layer 21 can be decreased, and the solid electrolyte layer 21 can be returned to the activated state.

Here, in a case where the read heater voltage is greater than or equal to a battery voltage, the control unit 10 applies a battery-equivalent voltage to the heater portion 24. However, since a voltage greater than the battery voltage can not be applied to the heater portion 24, the control unit 10 judges that a time for the internal resistance value “R1” of the solid electrolyte layer 21 to become the reference value is required, and the routine of the degradation judgment process proceeds to step S15. On the other hand, in a case where the read heater voltage is smaller than the battery voltage, the control unit 10 finishes the cycle of the degradation judgment process, and the routine proceeds to the normal control mode that judges the degradation of the electrode.

In the process of step S15, the control unit 10 refers to a map showing a relationship between the bulk resistance average value “Rav” and an activation delay, and reads an activation delay value corresponding to the bulk resistance average value “Rav” calculated by the process at step S12. The control unit 10, then, delays activation judgment timing by the read activation delay value.

With this process, the activation judgment timing can be delayed until the temperature of the solid electrolyte layer 21 increases, and the activation state of the solid electrolyte layer 21 can be accurately judged.

By this process, step S15 ends, and the routine of the degradation judgment process proceeds to step S16.

Here, in a case where the oxygen sensor 8 is not a pseudo-reference electrode type like the sensor illustrated in FIG. 2, the control unit 10 finishes the cycle of the degradation judgment process, and the routine proceeds to the normal control mode that judges the degradation of the sensor.

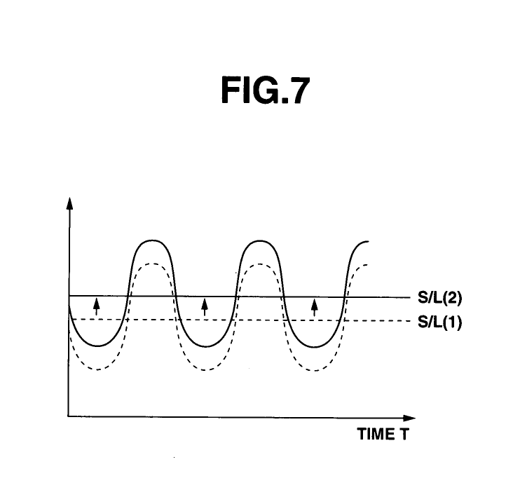

In the process of step S16, the control unit 10 refers to a map showing a relationship between the bulk resistance average value “Rav” and a slice level (S/L) offset amount, and reads the slice level offset amount corresponding to the bulk resistance average value “Rav” calculated by the process at step S12. The control unit 10, then, offsets the slice level of the output voltage “V” of the oxygen sensor 8 by the read offset amount (see FIG. 7).

More specifically, the control unit 10 offsets the slice level by a shift amount of the output voltage “V” of the oxygen sensor 8 with the change of the internal resistance value “R1”. In general, in the case where the oxygen sensor 8 is the pseudo-reference electrode type, it is difficult to lower the bulk resistance average value “Rav” to the reference value by the process at step S15. However, by this process, it is possible to adjust the output voltage “V” of the oxygen sensor 8 to an actual voltage, and the activation state of the solid electrolyte layer 21 can be accurately judged. By this process, the cycle of the degradation judgment process is terminated.

As is clear from the above explanation, in the embodiment, the control unit 10 detects the internal resistance value “R1” of the solid electrolyte layer 21 by applying the high-frequency alternating current between the reference electrode 23 and the measuring electrode 22. Then, the control unit 10 judges the degradation of the solid electrolyte layer 21 by comparing the average value “Rav” of the detected internal resistance value “R1” with the reference value. Hence, the degradation of the solid electrolyte layer 21 can accurately be judged, and an occurrence of the engine stall or emission failure can be prevented.

In addition, in the embodiment, when the average value “Rav” of the internal resistance value “R1” becomes greater than or equal to the reference value, the control unit 10 judges that the solid electrolyte layer 21 deteriorates. Then, the control unit 10 heats up the solid electrolyte layer 21 up to a temperature at which the internal resistance value “R1” becomes the reference value by controlling the applied voltage to the heater portion 24. Hence, it is possible to lower the internal resistance value “R1” of the solid electrolyte layer 21, and to return the solid electrolyte layer 21 to the activated state, and thereby obtaining a right sensor output.

Furthermore, in the embodiment, when the applied voltage corresponding to the temperature at which the internal resistance value “R1” becomes the reference value is greater than or equal to the battery voltage, the control unit 10 delays the timing at which the degradation of the solid electrolyte layer 21 is judged. Hence, by waiting for the sensor temperature to increase, the degradation of the solid electrolyte layer 21 can accurately be judged.

Moreover, in the embodiment, when the average value “Rav” of the internal resistance value “R1” becomes greater than or equal to the reference value, the control unit 10 judges that the solid electrolyte layer 21 deteriorates. Then, the control unit 10 raises the slice level, which is compared with the output value “V” of the oxygen sensor, more than a normal value according to the increment of the internal resistance value “R1” with respect to the reference value. Hence, the degradation of the solid electrolyte layer 21 can accurately be judged.

Finally, technical ideas that is comprehensible from the above embodiment, other than claims, will be described below together with their effects.

(i) The degradation judging device of the oxygen sensor as claimed in any one of the preceding claims 1 to 4, wherein, in a case of an increase of 50[%] or more of the internal resistance value of the solid electrolyte layer with respect to the reference value through the application of the alternating current of 10[MHz] high-frequency between the reference electrode and the measuring electrode, the degradation judging means judges that the solid electrolyte layer deteriorates.

1. A degradation judging device of an oxygen sensor having a reference electrode and a measuring electrode, both of which hold a solid electrolyte layer therebetween, and measuring oxygen concentrations based on an electromotive force that occurs in accordance with a difference between an oxygen partial pressure on a side of the reference electrode and an oxygen partial pressure on a side of the measuring electrode, the degradation judging device comprising:
a control unit detecting an internal resistance value of the solid electrolyte layer by applying a high-frequency alternating current between the reference and measuring electrodes, and judging degradation of the solid electrolyte layer by comparing the detected internal resistance value and a reference value.

2. The degradation judging device of the oxygen sensor as claimed in claim 1, wherein:
the control unit judges that the solid electrolyte layer deteriorates when the internal resistance value becomes greater than or equal to the reference value.

3. The degradation judging device of the oxygen sensor as claimed in claim 1, further comprising:
a heater portion for heating up the solid electrolyte layer,
wherein:
the control unit judges that the solid electrolyte layer deteriorates when the internal resistance value becomes greater than or equal to the reference value, and heats up the solid electrolyte layer to a temperature at which the internal resistance value becomes the reference value by controlling an applied voltage to the heater portion.

4. The degradation judging device of the oxygen sensor as claimed in claim 3, wherein:
when the applied voltage to the heater portion, which corresponds to the temperature at which the internal resistance value becomes the reference value, is greater than or equal to a battery voltage, the control unit delays a judging timing at which an activation state of the solid electrolyte layer is judged until the solid electrolyte layer heats up to the temperature at which the internal resistance value becomes the reference value.

5. The degradation judging device of the oxygen sensor as claimed in claim 3, wherein:
the control of the applied voltage to the heater portion is performed by a map or computation, which is formed by the internal resistance value of the solid electrolyte layer, a heater voltage and an activation judgment delay value.

6. The degradation judging device of the oxygen sensor as claimed in claim 3, wherein:
the control unit applies a 10 MHz high-frequency alternating current between the reference and measuring electrodes, and
in a case of an increase of 50 [%] or more of the internal resistance value of the solid electrolyte layer, the control unit judges that the solid electrolyte layer deteriorates.

7. A degradation judging device of an oxygen sensor provided with a reference electrode and a measuring electrode, both of which hold a solid electrolyte layer therebetween, the oxygen sensor measuring oxygen concentrations based on an electromotive force that occurs in accordance with a difference between an oxygen partial pressure on a side of the reference electrode and an oxygen partial pressure on a side of the measuring electrode, and having a system that accumulates the oxygen on the side of the reference electrode, the degradation judging device comprising:
a control unit detecting an internal resistance value of the solid electrolyte layer by applying a high-frequency alternating current between the reference and measuring electrodes, and judging degradation of the solid electrolyte layer by comparing the detected internal resistance value and a reference value.

8. The degradation judging device of the oxygen sensor as claimed in claim 7, wherein:
the control unit judges that the solid electrolyte layer deteriorates when the internal resistance value becomes greater than or equal to the reference value.

9. The degradation judging device of the oxygen sensor as claimed in claim 7, further comprising:
a heater portion for heating up the solid electrolyte layer,
wherein:
the control unit judges that the solid electrolyte layer deteriorates when the internal resistance value becomes greater than or equal to the reference value, and heats up the solid electrolyte layer to a temperature at which the internal resistance value becomes the reference value by controlling an applied voltage to the heater portion.

10. The degradation judging device of the oxygen sensor as claimed in claim 9, wherein:
when the applied voltage to the heater portion, which corresponds to the temperature at which the internal resistance value becomes the reference value, is greater than or equal to a battery voltage, the control unit delays a judging timing at which an activation state of the solid electrolyte layer is judged until the solid electrolyte layer heats up to the temperature at which the internal resistance value becomes the reference value.

11. The degradation judging device of the oxygen sensor as claimed in claim 10, wherein:
the control unit judges that the solid electrolyte layer deteriorates when the internal resistance value becomes greater than or equal to the reference value, and raises a slice level which is compared with an output value of the oxygen sensor, more than a normal value, according to an increment of the internal resistance value with respect to the reference value.

12. The degradation judging device of the oxygen sensor as claimed in claim 11, wherein:
the slice level being compared with the output value of the oxygen sensor is shifted by a map or computation, which is formed by the internal resistance value of the solid electrolyte layer, a heater voltage, an activation judgment delay value and a slice level offset amount.

13. The degradation judging device of the oxygen sensor as claimed in claim 11, wherein:
the control unit applies a 10 MHz high-frequency alternating current between the reference and measuring electrodes, and
in a case of an increase of 50 [%] or more of the internal resistance value of the solid electrolyte layer, the control unit judges that the solid electrolyte layer deteriorates.
